(19) United States
(12) Patent Application Publication
(10) Pub. No.: US 2005/0126755 A1
(43) Pub. Date: Jun. 16, 2005

(54) Method and apparatus for improved flame stabilization

(76) Inventors: Jonathan D. Berry, Meriden, CT (US); Shahrokh Etemad, Trumbull, CT (US); Hasan Karim, Bethany, CT (US); William C. Pfefferle, Madison, CT (US); Subir Roychoudhury, Madison, CT (US); Lance Smith, North Haven, CT (US)

Correspondence Address: Robert L. Rispoli;Precision Combustion, Inc., 410 Sackett Point Road, North Haven, CT, 06473, US

(21) Appl. No.: 10/979,071

(22) Filed: Oct. 29, 2004

Related U.S. Application Data
(60) Provisional application No. 60/516,658, filed on Oct. 31, 2003.

(51) Int. Cl. F02C 1/00

(52) U.S. Cl. 165/80.3

(57) ABSTRACT

A method and apparatus is provided for flame stabilization immediately downstream of a plurality of discrete fuel and air streams, prior to the mixing of the fuel and air, thereby preventing auto-ignition and flashback events. Coplanar and interspersed discrete fuel and air streams are introduced into a multiple channel monolith that imparts a swirl to the fuel and air streams, promotes immediate mixing, and initiates recirculation of the fuel and air mixture in a downstream combustion zone while promoting micro-scale vortex breakdown.

### CROSS-REFERENCE

This application claims the benefit of U.S. Provisional Application No. 60/516,658 filed Oct. 31, 2003.

### GOVERNMENT RIGHTS

This invention was made with government support under Department of Energy Agreement No. DE-FC26-02CH11133. The U.S. government has certain rights in this invention.

### FIELD OF THE INVENTION

The present invention is generally directed to a method and apparatus for utilizing a flameholder downstream of a plurality of discrete fuel and air streams. More particularly, the invention provides a flameholder that comprises a swirler arranged approximately flush with the plurality of discrete fuel and air streams thereby providing increased flame stability for the downstream combustion of a mixed fuel and air stream. In addition, the invention provides a method and apparatus whereby containment of a liberated part of an upstream partial conversion region may be achieved.

### BACKGROUND OF THE INVENTION

A number of combustion systems known in the art promote partial conversion of a fuel followed by complete combustion of that fuel in a downstream combustion zone. These methods generally comprise introducing a fuel and air mixture into a combustion zone wherein a portion of the fuel has been partially reacted prior to entering the combustion zone. Such partial reaction may be promoted chemically, catalytically, or by any other conventional means depending upon each particular application. As the partially reacted fuel and air mixture are introduced into a region of the combustion zone, as with a dump, a flame is established to promote complete combustion of the fuel within the fuel and air mixture.

Flame stabilization is a common problem in these combustion systems. A flame will propagate through a fuel-air mixture only when certain conditions prevail. Initially, a minimum percentage of fuel must be present within the fuel-air mixture to make the fuel-air mixture flammable; the lean flammability limit. Similarly, a maximum percentage of fuel must be present within the fuel-air mixture wherein greater than this percentage will prevent burning; the rich flammability limit. The flammability range of a fuel-air mixture is that range of the percentage of fuel within the fuel-air mixture between the lean flammability limit and the rich flammability limit.

As is known, the stoichiometry of a fuel-air mixture contributes to its flammability range. A stoichiometric fuel-air mixture composition contains sufficient oxygen for complete combustion thereby releasing all the latent heat of combustion of the fuel. The strength of a fuel-air mixture composition typically is expressed in terms of its equivalence ratio; the equivalence ratio being the actual fuel/air ratio divided by stoichiometric fuel-air ratio. For example, an equivalence ratio of one represents a stoichiometric fuel-air mixture composition. An equivalence ratio less than one represents a lean mixture and an equivalence ratio less greater than one represents a rich mixture.

As also is known, pressure and temperature contribute to the flammability range of fuel-air mixtures. Typically, with increases in pressure, the rich flammability limit is extended thereby extending the flammability range of the fuel-air mixture. Temperature, on the other hand, partially defines the flammability range of fuel-air mixtures. The lowest temperature at which a flammable fuel-air mixture can be formed, based upon the vapor pressure of the fuel at atmospheric pressure, is the flash point of that fuel-air mixture. Within the flammability range of a fuel-air mixture, at temperatures exceeding the flash point of the fuel-air mixture, auto-ignition of the fuel vapor occurs. Auto-ignition generally occurs at or slightly above the stoichiometric fuel-air mixture composition. The time interval between the mixing of the fuel-air mixture such that it is combustible and the auto-ignition of that fuel-air mixture is known as the auto-ignition delay time.

One reason that flame stabilization is required in combustion systems is to prevent the flame front from moving upstream from the combustion zone toward the source of fuel; a flashback. During a flashback event, the heat of combustion moves upstream and may damage numerous structures within the fuel and air mixing region of the combustor. Flashback may occur due to auto-ignition of a fuel-air mixture caused by a residence time of the fuel-air mixture in a region upstream of the combustion zone that exceeds the auto-ignition delay time of that fuel-air mixture at the temperature and pressure of that region.

Flame stabilization also is dependent upon speed of the fuel-air mixture entering the combustion zone where propagation of the flame is desired. A sufficiently low velocity must be retained in the region where the flame is desired in order to sustain the flame. As is known, a region of low velocity in which a flame can be sustained can be achieved by causing recirculation of a portion of the fuel-air mixture already burned thereby providing a source of ignition to the fuel-air mixture entering the combustion zone. However, the fuel-air mixture flow pattern, including any recirculation, is critical to achieving flame stability.

One method known for causing recirculation is the placement of a bluff body in the flow path of the fuel-air mixture within the combustion zone. A bluff body typically defines a leading edge and a trailing edge, and separation of a mixture passing over the bluff body occurs at the trailing edge of the bluff body thereby forming a wake downstream of the trailing edge. The velocity of the fuel-air mixture in the wake region is much lower than the velocity of the fuel-air mixture flowing in the main stream around the bluff body thereby supporting recirculation. One problem associated with using a bluff body as a flame holder is that the flame is anchored to the flame holder and the excessive heat is life-limiting.

As also is known, adding a swirl component to the flow pattern is beneficial, either axial or radial or an axial/radial swirl. The use of a swirler to cause recirculation is typical in combustion systems. The designation of a swirl number for a particular type of swirler is known: a swirl number less than around 0.4 indicates a weak swirl and no recirculation is obtained; a swirl number between 0.4 and 0.6 indicates a moderate swirl and no recirculation is obtained but the streamlines diverge; and a swirl number greater than 0.6 indicates a strong swirl and recirculation is obtained.

One approach for promoting a stable flame in a combustion system comprising partial conversion of a fuel followed by complete combustion of that fuel in a downstream combustion zone is described in U.S. Pat. No. 5,518,697 to Dalla Betta et al (the '697 patent). A fuel stream is partially combusted in a catalyst structure followed by complete homogeneous combustion downstream of the catalyst structure. The '697 patent discloses a catalyst structure that comprises catalytic and non-catalytic channels in heat exchange relationship in order to promote more complete combustion of the fuel flowing through the catalytic channels and minimum combustion of the fuel flowing through the non-catalytic channels. According to the '697 patent, flame stability can be achieved by the addition of a flameholder or other means for inducing gas recirculation into the partially combusted fuel-air mixture downstream of the outlet end of the catalyst structure. (See the '697 patent, Columns 5, line 41, to Column 6, line 6).

In the Dalla Betta device, a flameholder typically is positioned at a point in the combustion zone downstream of the catalyst structure outlet such that the average residence time of the partially-combusted fuel in the region of recirculation created by the flameholder approximates the auto-ignition delay time for the specific fuel-air mixture and temperature present in the combustion zone. (See the '697 patent, Column 17, lines 6-13). According to the '697 patent, to obtain effective gas flow recirculation, the flameholder or combination of flameholders employed must provide a geometric flow blockage in the homogenous combustion zone of about 5-90%, preferably 20-70%. (See the '697 patent, Columns 16, lines 59-65).

One problem associated with the Dalla Betta device is that the fuel component of the fuel-air mixture passes through both the catalytic and non-catalytic channels with heat transfer from the catalytic channels to the non-catalytic channels. As a result, the flow through the non-catalytic channels, which is minimally combusted as described in the '697 patent, exits the catalytic structure in a heated state. Accordingly, auto-ignition of this minimally combusted fuel stream may occur at the exit of the catalytic structure causing a flashback event into the non-catalytic channels and loss of required cooling for the catalytic channels.

Another problem with the Dalla Betta device is that many applications, particularly partial catalytic combustion followed by complete combustion in a combustion zone with a gas turbine engine, operate more efficiently when the fuel-air mixture flow pattern is not impeded or obstructed by a flame holder. A flame holder according to the '697 patent, as with most conventional flame holders, obstructs a flow path to create a recirculation zone for flame stability. This in turn causes an increase in residence time for a portion of the fuel-air mixture. When the residence time falls within the auto-ignition delay time for the fuel-air mixture at the prevailing conditions, the mixture will ignite as desired with the flame being anchored to the flame holder. Moreover, many combustion system applications require much less pressure drop than that associated with a flameholder that exhibits geometric flow blockages in the range disclosed in the '697 patent.

It is known in the art that an approach for promoting a stable flame in a combustion system comprising partial conversion of a fuel followed by complete combustion downstream (in order to promote low emissions) is to place a swirler downstream of the partial conversion device. Until now, this approach has been disadvantageous in that a flashback event, such as from a flow disturbance, will destroy the swirler. Thus, the teachings of the prior art teach away from positioning a swirler downstream of a fuel flow.

One approach for promoting a stable flame is to position a swirler downstream of a partial conversion reactor and upstream of a fuel and air premix region. By not premixing the fuel and air upstream of the swirler, a catastrophic flashback event is fundamentally eliminated and lower emissions result from the combustion process. However, adequate mixing downstream of a swirler, and thus achieving sufficiently low emissions, is difficult to achieve.

One of the problems associated with partial conversion catalytic devices as previously described is overcome by the method and apparatus taught in U.S. Pat. No. 6,358,040 to Pfefferle et al. (the '040 patent), incorporated herein by reference. As taught at Column 7, line 57 to Column 8, line 47, the apparatus of Pfefferle employs a plurality of conduits positioned within a housing, the conduits adapted for conducting a fluid through the housing. The housing is subdivided by an upstream plate into a first zone and a second zone that are not in fluid communication, the first zone being upstream of the second zone, and the second zone being defined by the upstream plate, the housing inner surface, and the conduit exterior surfaces. The housing also defines an aperture in fluid communication with the second zone.

The conduits are placed within the housing penetrating through the upstream plate such that the conduit entrances open into the first zone of the housing and the conduits conduct a fluid through the second zone while not in fluid communication with the second zone. The first zone defines a flow path permitting a cooling fluid to enter into the first zone and pass through the conduits. A fuel-air mixture enters the second zone through the aperture and traverses the flow path defined by the conduit exteriors and the housing inner surface. The first zone (conduit) exits and the second zone flow path exit plane (the spaces between the conduit exteriors and along the housing inner surface around the conduit exteriors) are co-located and interspersed so that the fluid streams exiting both zones will mix. As further taught by Pfefferle at Column 8, lines 3346, the structure of the first zone exits proximate with the second zone exit plane provide immediate small scale mixing of the cooling fluid stream and the partial conversion product stream. As described in Column 10, lines 31-16, the non-homogeneous mixture is then mixed to create a fuel lean fuel-air mixture which is then conducted into a combustion zone.

Pfefferle overcomes the auto-ignition problem associated with the Dalla Betta device wherein the fuel component of the fuel-air mixture passes through both the catalytic and non-catalytic channels. In the Pfefferle device, cooling air is passed through the conduits (non-catalytic channels) to backside cool, the catalytically-coated conduit exterior surfaces which, together with the housing, define a catalytic channel. Because the catalytic channel is operated fuel rich, flashback is not an issue. Moreover, no fuel is present for combustion in the non-catalytic channels. Thus, if flashback occurs in a downstream mixing zone, it s impact to the reactor is minimal or non-existent. However, emission control is lost.

One of the problems associated with the Pfefferle device, as with all partial conversion combustion systems continues to be flame stability. Another potential problem associated with many partial conversion combustion systems is the potential for components of the system to liberate or otherwise be released to traverse downstream of the partial conversion region.

Based on the foregoing, it is an objective of the present invention to provide a method and apparatus for improved flame stabilization that provides flame holding and prevents auto-ignition and flashback events. It is an objective of the present invention to overcome the auto-ignition and flashback disadvantages associated with introducing fuel and air in a premixed form to a flame holder for combustion. Alternatively stated, it is an object of the present invention to eliminate the possibility of loss of emission control by eliminating a post-catalyst mixing zone prior to combustion. Another object of the present invention is to provide a method and apparatus for flame stabilization whereby pressure loss due to flow blockage is reduced or eliminated. Another object of the present invention is to provide a method and apparatus whereby rapid mixing of a plurality of discreet flow streams is promoted. Lastly, another object of the present invention is to provide a method and apparatus whereby containment of a liberated part of the upstream partial conversion region may be achieved.

### SUMMARY OF THE INVENTION

The present invention teaches a method and apparatus for utilizing a flameholder of specific geometric properties downstream of a plurality of discrete and separate fuel and air streams in a combustion system that promotes partial conversion of a fuel followed by complete combustion of that fuel in a downstream combustion zone. The flameholder preferably comprises a swirler arranged approximately flush with the plurality of discrete and separate fuel and air streams. The configuration taught by the present invention provides increased flame stability for the downstream combustion of a mixed fuel and air stream. The present invention provides increased flame stability for both catalytic and non-catalytic type combustion systems.

The method and apparatus of the present invention takes advantage of the configuration of a partitioned flowpath taught by in the '040 patent (previously incorporated by reference and described herein). Conduits divide an air stream into a plurality of discrete air streams and conduct the discrete air streams through a housing from a first zone upstream of the housing to the conduit exits. Concurrently, a rich fuel-air mixture, referred to herein as a fuel stream, is conducted through a second zone within the housing defined by the housing inner surface and the conduit exterior surfaces. The fuel stream is conducted to discrete exits that form a second zone exit plane wherein such fuel stream discrete exits are co-located and interspersed between discrete air stream exits. The present invention teaches the use of a swirler configuration that is particularly advantageous when arranged as taught herein, namely, downstream and approximately flush with the plurality of discrete and separate fuel and air streams.

A swirler according to the present invention is comprised of one or more multiple channel monoliths placed across the plurality of discrete and separate fuel and air streams. Substantially all the fuel and air passes through the swirler such that bypass is practically eliminated. The monolith swirler contains numerous channels with each channel being defined by walls having a length, a mean hydraulic diameter, and a spatial orientation. The mean hydraulic diameters of the channels are application dependent, considering the fuel, the fuel/air ratio, and the channel length. In general, the mean hydraulic diameters of the channels can always be less than the critical quenching diameter as described in U.S. Pat, No. 6,179,608 to Kraemer et al. (the '608 patent), incorporated herein by reference. Particular reference is made to the '608 patent, Column 1, line 57 to Column 4, line 2, and Column 5, lines 33 to Column 6, line 17, wherein a downstream monolith swirler component of a swirling flashback arrestor is disclosed.

The monolith configuration taught in the '608 Patent is intended to impart a swirl to a premixed fuel and air stream prior to combustion. The problems associated with introducing a premixed fuel and air stream upstream of a swirler are discussed herein with reference to the prior art. As a device according to the '608 patent introduces a certain degree of swirl, a large and stable recirculation zone develops along the symmetry axis. This is known in the art as vortex breakdown and is known to be a desired flow pattern in low-emission combustion sections comprising Lean Premixed Prevaprised (LPP) technology. In such systems, air and fuel are vaporized completely prior to combustion thereby achieving desired low emissions.

Within an apparatus according to the present invention, a swirler of a particular configuration provides flame holding and initiates recirculation of the fuel and air mixture in a downstream combustion zone. Mixing of the separate and discrete fuel streams and air streams upstream of the swirler is not permitted and thereby avoids any issue from auto-ignition or flashback events previously described with reference to the prior art. Moreover, an apparatus according to the present invention provides active cooling of the swirler by both the fuel streams and the air streams. Rather than conventional cooling of swirler vanes with fuel by convective cooling, the plurality of discrete fuel and air streams provide cooling by contact with the monolithic swirler walls. An apparatus according to the present invention also promotes a plurality of a substantially smaller scale recirculation zones immediately downstream of the respective swirler channel exits. Such micro-scale vortex breakdown significantly enhances the mixing and recirculation characteristics of the present invention over the prior art.

In one embodiment of the present invention, a 45-degree swirler with an open center was installed flush with the exit of a plurality of conduits; such apparatus conducting a plurality of discrete and separate fuel and air streams through a housing as described above. The configuration of this embodiment produced a toroid-shaped flame at low equivalence ratios. As the equivalent ratio was increased, the flame moved outward from the middle and became a very tight and bright spiral flame with distinct regions of vortex breakdown that anchored the flame away from the swirler itself. Operating at an equivalence ratio of less than 0.35, an apparatus of the present invention achieved stable combustion with very low emissions (NOx, CO, and UHC). In addition, large-scale acoustics were nonexistent. Moreover, such stable combustion, low emissions and nonexistent large-scale acoustics were obtained well below the typical lean limit for methane without the use of a pilot to stabilize or anchor the flame.

One advantage of the present invention is the enablement of rapid mixing of the fuel streams and the air streams immediately downstream of the swirler exit, in one embodiment within an inch of the discrete fuel and air streams, thereby resulting in a very compact combustion zone. The integration of a monolithic swirler with distributed fuel and air injection points into the swirler, such points defined by the conduit exits and the regions between the conduits, has enabled small scale mixing to be achieved very rapidly. This novel approach is significant advance for non-premixed systems.

Another advantage of the present invention is that it enables combustion to occur within a constant diameter duct. In other words, rather than a need for expansion to reduce velocity, the duct velocity accelerates due to gas expansion. Virtually all prior art combustion systems employ a dump or expansion region in order to stabilize a flame by greatly reducing the velocity of the fuel and air stream.

The present invention teaches flame stabilization within a constant (non-expanding) diameter duct by aerodynamically anchoring the flame in small low velocity pockets generated by vortex breakdown. The combination of multiple independent fuel and air streams and the very thin walls of the monolithic swirler are not conducive to flame holding (that is, anchoring the flame to the swirler). In order for flame holding to occur, fuel and air must be mixed and provided a low velocity region to reside. Virtually no mixing of the streams occurs upstream of the conduit exits and minimal mixing of the streams occurs within the swirler channels. A channel wall thickness (and leading edge facing the downstream-flowing discrete fuel and air streams) of approximately 0.005 inch foil thickness does not produce a sufficiently low-velocity region for flame stabilization. In contrast, vortex breakdown occurs just downstream of the swirler thereby enabling flame holding to be achieved.

The present invention enables near stoichiometric combustion to occur immediately downstream of the swirler without component failure. Impingement cooling with both fuel streams and air streams on the swirler provides for enhanced heat transfer. Stoichometric combustion in close proximity to the flameholder formerly was impractical without active cooling by an external (non-participating) flows. When mixed, such external flows lower the overall equivalence ratio of the resulting fuel-air mixture prior to combustion, and yield a high equivalence ratio with high emissions after combustion has taken place. In contrast, the present invention utilizes participating air flows to cool the swirler. The close coupling of the distributed points of fuel and air with a swirling monolith has eliminated the need for non-participating flows. Accordingly, the present invention advantageously promotes the lowest possible overall equivalence ratio thereby minimizing emissions.

Moreover, in an apparatus according to the present invention, the flame is not anchored to the flame holder or swirler itself, and instead the flame is held some distance downstream off of (that is, not in contact with) the swirler.

It is yet another advantage of the present invention that when employed in combination with a reactor as described in the '040 patent, the present invention teaches a method for the containment of any liberated catalytic components in the event of a failure.

Many practitioners are investigating methods to improve the Rich-burn/Quick-quench/Lean-burn combustor concept wherein combustion is initiated in a fuel-rich primary zone and NOx formation rates are low due to the combined effects of low temperature and oxygen depletion. A comprehensive of the RQL combustor is provided by Arthur H. Lefebvre, Gas Turbine Combustion, pages 363-366 Second Edition, 1999), incorporated herein by reference. It is yet another advantage of the present invention that when employed in combination with a RQL combustor, the problems associated with long residence times, unstable recirculation patters, and non-uniform mixing are substantially reduced or eliminated.

### BRIEF DESCRIPTION OF THE DRAWINGS

FIG. 1 depicts a longitudinal cross-section of an embodiment of a combustion system that promotes partial conversion of a fuel followed by complete combustion of that fuel in a downstream combustion zone as taught by the '040 patent. FIG. 1 depicts prior art.

FIG. 2 depicts a longitudinal cross-section of an embodiment of the present invention comprising a swirler configuration positioned approximately flush with a plurality of discrete fuel and air streams in a combustion system that promotes partial conversion of a fuel followed by complete combustion of that fuel in a downstream combustion zone.

FIG. 3 is an isometric view of a swirler configuration comprising an axial swirling monolith.

FIG. 4 is a cross-sectional view of the swirler configuration depicted in FIG. 3.

FIG. 5 is a view of the downstream face of the monolith of the swirler configuration depicted in FIG. 3 showing the resulting axial swirl pattern.

### DETAILED DESCRIPTION OF THE INVENTION

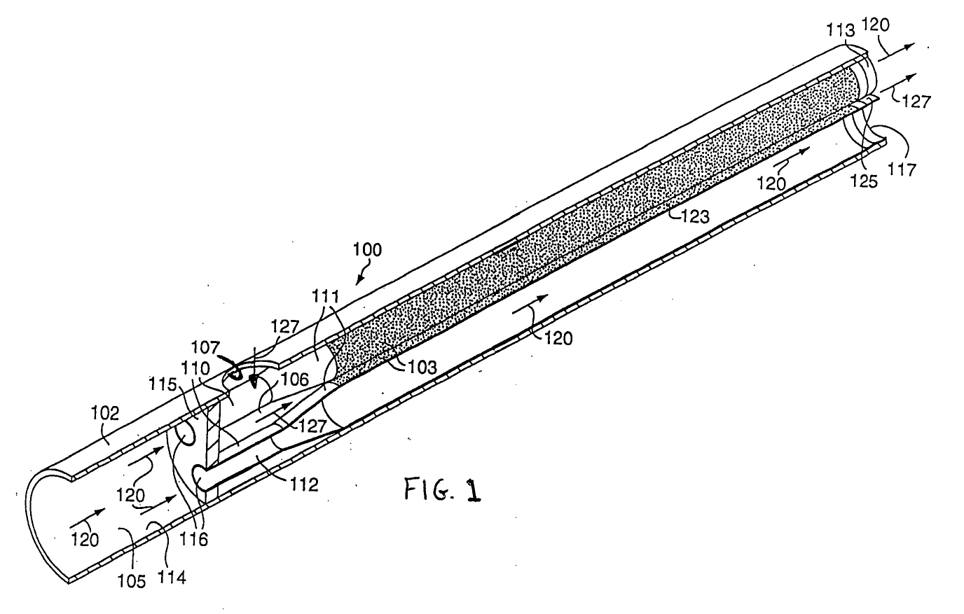

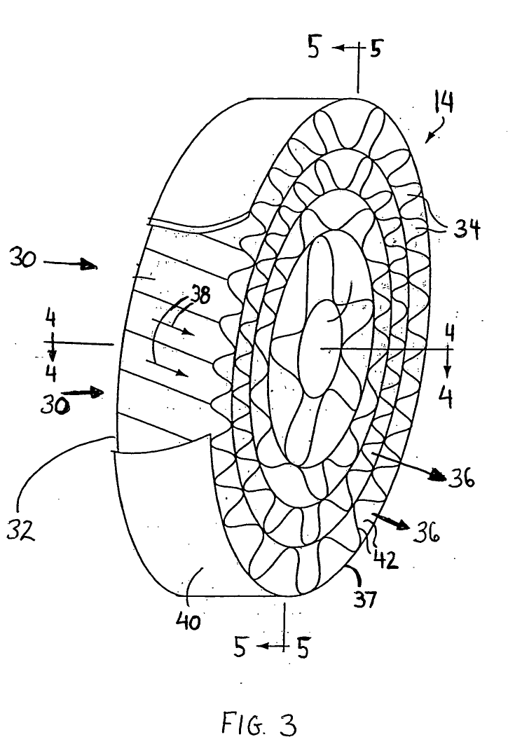

FIG. 1 depicts a longitudinal cross-section of an embodiment of a combustion system that promotes partial conversion of a fuel followed by complete combustion of that fuel in a downstream combustion zone as taught by the '040 patent (See the '040 patent FIG. 3; and Column 10, line 24 through Column 11, line 6). The orientation of upstream and downstream is based on the normal and desired direction of a flow path through a combustion system from a fuel source toward a combustion region. In the embodiment shown, the apparatus comprises a catalytic reactor 100 comprised of a housing 102 having an entrance and an exit, and defining at least one aperture 107. A plate 115 is positioned within the housing 102 defining a first zone 105 and a second zone 106. The aperture 107 is in fluid communication with the second zone 106.

At least two conduits 110 adapted for conducting a fluid are positioned within the housing 102. The conduits have an entrance 116, an exit 117 with an exit periphery 113, an interior surface 112, and an exterior surface 111. The conduits 110 are positioned within the housing 102 such that the conduits 110 penetrate plate 115 thereby having the conduit entrances 116 in fluid communication with the first zone 105 and the conduit exits within a downstream portion of the second zone 106. A first fluid 120 entering first zone 105 must enter second zone 106, if at all, by exiting conduits 110. The conduit exit periphery 113 positions the conduits 110 relative to each other and the housing interior surface 114. The flow path 123 within housing 102 is defined by the conduit exterior surfaces 111. The flow path extends between the aperture 107 and the flow path exits 125, which are defined by the conduit exit peripheries 113. Downstream of the aperture 107, the flow path 123 allows for a second fluid 127 to disperse throughout housing 102. Further downstream, the flow path 123 is subdivided into a plurality of smaller passages by the expanding cross-section of the conduits 110 positioned to be in contact one with another. In the embodiment depicted, a catalyst 103 has been deposited on a portion of the conduit exterior surface 111 downstream of aperture 107.

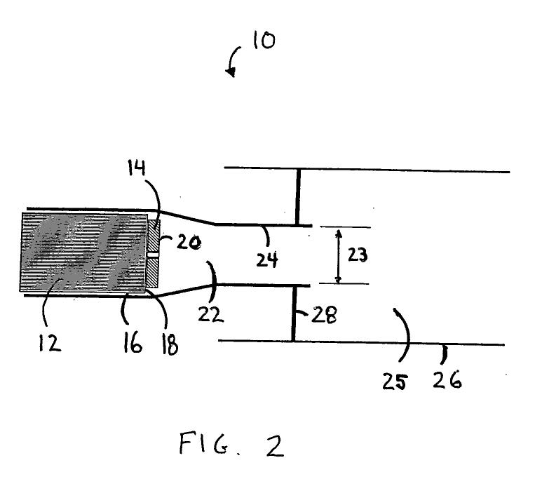

FIG. 2 depicts a longitudinal cross-section of a partial conversion combustion system 10 wherein a fuel-air mixture fuel stream is partially combusted in a catalytic reactor 12, such reactor being an embodiment of the '040 patent. Accordingly, a plurality of discrete fuel and air streams exit catalytic reactor 12 at a downstream face 18 of catalytic reactor 12. A monolith swirler 14 is positioned approximately flush with downstream face 18 of catalytic reactor 12. Fuel streams and air streams pass through the monolith swirler 14 and exit the monolith swirler 14 at exit plane 20 with an imparted swirl. A combustion region 22 is shown as contracting to a cross area 23 equivalent with the area of the catalytic reactor 12 excluding the reactor walls; hence, a constant non-expanding combustion zone.

A constant area passage 24 extends into a dump region 25 where velocity is decreased and any uncombusted fuel exhibiting a sufficiently high equivalence can completely combust prior to the venting of the exhaust gases. While the embodiment depicted comprises a constant area combustion zone, the present invention may similarly comprise and expanding area combustion zone or a contracting area combustion zone based upon a particular application. In another embodiment of the invention, the combustor liner 26 may be backside cooled and correspondingly employed to preheat inlet air to the system. A combustion liner seal 28 is in communication with combustor liner 26 and constant area passage 24.

FIG. 3 is an isometric view of axial swirling monolith 14. The plurality of discrete fuel and air streams that exits housing 16 at downstream face 18 of catalytic reactor 12 is depicted as fluid 30. The fluid 30 enters monolith 14 at an upstream face 32 of monolith 14. The fluid 30 enters channels 34 through upstream face 32. Substantially all the fluid 30 must pass into monolith 14 thereby preventing bypass of fluid 30 around monolith 14.

At least one channel 34 defines a flow path that imparts a swirl component to the fluid 30 that traverses the channel 34. In the depicted embodiment, all channels 34 impart a complimentary axial swirl so that the entire flow 36 exiting channels 34 through downstream face 37 adopts flow direction 38. In this embodiment, monolith 14 is depicted as an assembly comprising an outer ring 40. The orientation of the channels 34 promotes mixing of fluid 30 in addition to adding a swirl component to fluid 30. A practical minimum to add a swirl component is a theta of 10 degrees. As theta increases, a threshold will be achieved where the flow 36 exiting downstream face 37 of monolith 14 will develop a recirculation flow pattern that will have vortex breakdown. A recirculation zone should form when theta is greater than about 45 degrees. At this condition the swirl number should be about 0.5. It is preferred that the spatial orientation of the channels 34 within monolith 14 be the same or generally the same.

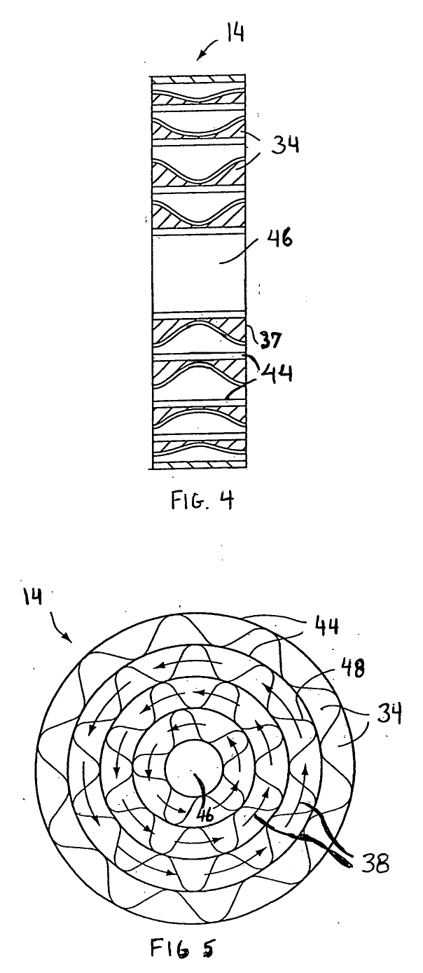

FIG. 4 is a cross-sectional view of the monolith 14 The monolith channels 34 are oriented to impart an axial flow. As the monoliths in this configuration are made using the concentric method (discussed below), separators 44 are perpendicular to the face of the monolith 14. In this embodiment, monolith 14 also comprises a hub 46 that defines a void. If a void is present, the void serves as a flashback arrestor. Other hubs are possible, such as solids or even other channeled configurations. The hub performs various functions; for example assisting in creating a recirculation zone; providing a fuel injector insertion point; promoting structural strength; or positioning the monolith. As those skilled in the art will recognize, the hub creates in essence a dead zone while employing a solid hub reduces the theta required to obtain a recirculation zone. The surface area of the hub is practically limited to one-quarter the frontal area of the monolith to maintain a reasonable pressure loss.

FIG. 5 is a view of the downstream face 37 of concentric monolith 14. The corrugated partition 48 and the flat partition that defines separators 44 cooperate to define the channels 34. The flow direction 38 depicts the flow direction for a fluid exiting the channels 34.

While the present invention has been described in considerable detail with reference to utilizing a monolithic swirler downstream of a plurality of discrete and separate fuel and air streams, other geometric configurations exhibiting the characteristics taught herein for flame stabilization for both catalytic and non-catalytic type combustion systems are contemplated. Therefore, the spirit and scope of the invention should not be limited to the description of the preferred embodiments described herein.

1. A system for improved flame stability comprising:
a. means for providing a plurality of substantially coplanar discrete fuel streams and discrete air streams;
b. means for imparting a swirl to the coplanar discrete fuel streams and discrete air streams prior to less than nominal mixing of the discrete fuel streams and discrete air streams;
c. means for immediately mixing the discrete fuel streams and discrete air streams upon imparting the swirl; and
d. combusting a mixed fuel and air stream in a combustor.

2. The system for improved flame stability of claim 1 wherein the means for providing a plurality of substantially coplanar discrete fuel streams and discrete air streams comprises:
a. a housing defining an enclosure having an exit plane;
b. an upstream plate dividing the housing into a first zone upstream of the plate and a second zone downstream of the plate, wherein the first zone is not in fluid communication with the second zone and the second zone defines an exit plane coplanar with the housing exit plane;
c. an aperture in the housing in fluid communication with the second zone and defining a flow path through the second zone from the aperture to the second zone exit plane;
d. a plurality of conduits positioned within the housing and penetrating the upstream plate, whereby the conduits are adapted to define first zone discrete flow paths from the first zone to the second zone exit plane; and
e. the conduits and the second zone exit plane are adapted to define a plurality of second zone discrete flow paths coplanar and interspersed with the first zone discrete flow paths.

3. The system for improved flame stability of claim 2 further comprising a means for retaining and preventing a conduit from passing through the combustor.

4. The system for improved flame stability of claim 2 wherein the means for imparting a swirl further comprises at least one multiple channel monolith positioned immediately downstream of the second zone exit plane.

5. The system for improved flame stability of claim 4 wherein substantially all of the channels of the multiple channel monolith comprise a spatial orientation of approximately 45 degrees.

6. The system for improved flame stability of claim 4 wherein the multiple channel monolith positioned immediately downstream of the second zone exit plane defines micro-scale vortex breakdown.

7. The system for improved flame stability of claim 4 wherein the multiple channel monolith further comprises an open hub.

8. The system for improved flame stability of claim 1 wherein a fuel stream is first partially oxidized prior to separation into discrete fuel streams.

9. The system for improved flame stability of claim 2 wherein a fuel stream is first partially oxidized within the second zone prior to separation into discrete fuel streams at the second zone exit plane.

10. The system for improved flame stability of claim 9 wherein a portion of the conduit exterior surface within the second zone is coated with a catalyst for promoting partial oxidation of the fuel stream.

11. A method for improved flame stability comprising:
a. providing a plurality of substantially coplanar and interspersed discrete fuel streams and discrete air streams;
b. introducing the discrete fuel streams and discrete air streams into a multiple channel monolith;
c. imparting a swirl to the discrete fuel streams and discrete air streams;
d. immediately mixing the discrete fuel streams and discrete air streams exiting the swirler; and
e. combusting the mixed fuel and air stream in a combustor.

12. The method for improved flame stability of claim 11 wherein the step of imparting a swirl further comprises positioning at least one multiple channel monolith immediately downstream of the coplanar and interspersed discrete fuel streams and discrete air streams.

13. The method for improved flame stability of claim 12 wherein substantially all of the channels of the multiple channel monolith comprise a spatial orientation of approximately 45 degrees.

14. The method for improved flame stability of claim 12 wherein the multiple channel monolith positioned immediately downstream of the second zone exit plane defines micro-scale vortex breakdown.

15. A system for improved flame stability in a partial conversion combustion system comprising:
a. a housing defining an enclosure having an exit plane;
b. an upstream plate dividing the housing into a first zone upstream of the plate and a second zone downstream of the plate wherein the first zone is not in fluid communication with the second zone and the second zone defines an exit plane coplanar with the housing exit plane;
c. an aperture in the housing in fluid communication with the second zone and defining a flow path through the second zone from the aperture to the second zone exit plane;
d. a plurality of conduits positioned within the housing and penetrating the upstream plate, whereby the conduits are adapted to define first zone discrete flow paths from the first zone to the second zone exit plane;
e. the conduits and the second zone exit plane are adapted to define a plurality of second zone discrete flow paths coplanar and interspersed with the first zone discrete flow paths;
f. a catalyst positioned on at least a portion of a conduit exterior surface located within the second zone for promoting partial oxidation of a fuel stream;
g. conducting an air stream fluid through the conduits thereby defining a plurality of discrete air streams at the second zone exit plane;
h. conducting a fuel stream through the second zone thereby defining a plurality of discrete fuel streams at the second zone exit plane;
i. at least one multiple channel monolith positioned immediately downstream of the second zone exit plane adapted to impart a swirl to multiple discrete flow streams;
j. introducing the discrete fuel streams and discrete air streams into the monolith;
k. immediately mixing the discrete fuel streams and discrete air streams upon exiting the monolith; and
l. combusting the mixed fuel and air stream in a combustor.

16. The system for improved flame stability of claim 15 wherein substantially all of the channels of the multiple channel monolith comprise a spatial orientation of approximately 45 degrees.

17. The system for improved flame stability of claim 15 wherein the multiple channel monolith positioned immediately downstream of the second zone exit plane defines micro-scale vortex breakdown.

18. The system for improved flame stability of claim 15 wherein the multiple channel monolith positioned immediately downstream of the second zone exit is adapted for retaining and preventing a conduit from passing through the combustor.
